(19) United States
(12) Patent Application Publication
(10) Pub. No.: US 2022/0327448 A1
(43) Pub. Date: Oct. 13, 2022

(54) A SERVICE MODEL QUANTITATIVE EVALUATION METHOD FOR CROSSOVER SERVICES

(71) Applicant: ZHEJIANG UNIVERSITY, HANGZHOU, Zhejiang Province (CN)

(72) Inventors: Jianwei YIN, HANGZHOU, ZHEJIANG PROVINCE (CN); Meng XI, HANGZHOU, ZHEJIANG PROVINCE (CN); Shuiguang DENG, HANGZHOU, ZHEJIANG PROVINCE (CN); Jintao CHEN, HANGZHOU, ZHEJIANG PROVINCE (CN); Yongna WEI, HANGZHOU, ZHEJIANG PROVINCE (CN); Siwei TAN, HANGZHOU, ZHEJIANG PROVINCE (CN); Zhaohui WU, HANGZHOU, ZHEJIANG PROVINCE (CN)

(21) Appl. No.: 17/425,728

(22) PCT Filed: Jul. 10, 2020
(86) PCT No.: PCT/CN2020/101253

§ 371 Date: Jul. 25, 2021

(30) Foreign Application Priority Data
May 19, 2020 (CN) 202010424881.5

(51) Int. Cl. G06Q 10/06

(52) U.S. Cl. CPC G06Q 10/0639

(57) ABSTRACT

The present invention discloses a service pattern quantitative evaluation method for crossover services: defining top elements of the service pattern, including defining participants, workflow, data flow, resource flow and cash flow; describing participants in the service pattern; describing the workflow among the participants based on existing participants; on the basis of the workflow among the participants, describing the data flow among the participants; on the basis of the workflow among the participants, describing the resource flow among the participants; on the basis of the workflow among the participants, describing the cash flow among the participants; based on the described workflow, data flow, resource flow and cash flow, calculating the evaluation indicators of the service pattern, including running time, consumption cost, transfer efficiency, value, and reliability; and calculating pattern entropy based on the evaluation indicators to conduct overall evaluation of the service pattern. This method can help product managers, entrepreneurs, business consultants and business designers conduct quantitative evaluation of existing service patterns.

### TECHNICAL FIELD

The present invention relates to the technical field of software engineering, more specifically relates to the field of service computing in business process management, and in particular relates to a service pattern quantitative evaluation method for crossover services.

### BACKGROUND OF TECHNOLOGY

The service pattern refers to the distribution method of data, resource and cash among different participants in the service system. Crossover service pattern is a novel cross-field-boundary service pattern. On one hand, the cross-over can be realized through coordination across the boundaries of different enterprises and organizations. On the other hand, the cross-over can also be achieved by integrating resources of different fields to break through the upstream and downstream of the business. Different from conventional service pattern, due to that a single service involves multiple fields, generally, more participants are involved in crossover service pattern. Besides, along with the mutual call among the business service units, generation, transfer and exchange of data, resource and cash also occur among the participants.

Currently, crossover service pattern is primarily realized through integrating existing service resources of different fields. In conventional monolithic architecture, due to high coupling of code logic and business logic, business capacity is internalized. When deploying crossover service pattern, code refactoring is required to penetrate the business capacity, consuming huge amount of labor and time. Therefore, in crossover service pattern, most companies and enterprises package their services into separate business service unit to interact with the services of other companies, sectors or fields.

In crossover service environment, the business system is completely component-oriented and service-oriented, there is hardly any coupling between services, providing good expandability and repeatability. Conventional modeling and evaluation methods primarily focus on the service process and business logic experienced by individual users when using the service. In recent years, due to the emerging of crossover service pattern, modeling methods for multi-user complex process scenario have gradually become the focus of concern in the industrial community. In crossover service pattern, it has become more important to analyze and optimize the transfer of data, resource and cash among the participants. Others have modeled the service pattern, and described the business model from three aspects. However, up to now, no one single model has provided both modeling and analysis of processes, data, resources and cashes at the same time.

When designing service process, existing service providers generally take function realization as objective of priority, considering the rationality of the business logic. However, in crossover service pattern, additional time and cost are introduced into the process operation as a result of the coordination among multiple participants. How to optimize the business logic has become an important approach to crossover service pattern optimization.

Besides, crossover service is generally deployed on specific server, resulting in the correlation of QoS indicators such as operation efficiency, bandwidth and reliability with the computing environment. The coordination among different platforms can also bring additional burden to the whole system. Therefore, it is necessary to conduct quantitative evaluation of the current state of specific crossover service pattern, so as to realize quantitative analysis of the service pattern, in a bid to provide support for the optimization of the methods for participants cooperation, service selection, activity orchestration and resource distribution etc.

### SUMMARY OF THE INVENTION

In consideration of the disadvantages of the prior art, the present invention provides a service pattern quantitative evaluation method for crossover services to help product managers, entrepreneurs, business consultants and business designers conduct quantitative evaluation of existing service patterns.

The service pattern quantitative evaluation method for crossover services of the present invention, comprising:

(1) defining top elements of crossover service pattern, including defining participant, workflow, data flow, resource flow and cash flow;

(2) describing participants in the service pattern;

(3) describing the workflow among the participants based on existing participants;

(4) on the basis of the workflow among the participants, describing the data flow among the participants;

(5) on the basis of the workflow among the participants, describing the resource flow among the participants; (6) on the basis of the workflow among the participants, describing the cash flow among the participants;

(7) based on the described workflow, data flow, resource flow and cash flow, calculating the evaluation indicators of the service pattern, including running time, consumed cost, transfer efficiency, value, and reliability; and calculating pattern entropy based on the evaluation indicators to conduct overall evaluation of the service pattern, wherein the lower the value of the pattern entropy is, the better the service pattern is.

The service pattern in the present invention describes the relationship among the participants from four different aspects: workflow, data flow, resource flow and cash flow.

The attribute of the participant comprises role name, role type, and nodes of role participation, the nodes of role participation can be activity, gateway or event. Further, the role types include but not limited to provider, consumer, third party platform; the activity node, gateway node and event node of the nodes of role participation shall correspond to the activity node, gateway node and event node in the workflow of the service pattern one by one.

The workflow comprises activity node, gateway node, event node and logical relationship.

The attribute of the activity node comprises name, carrier, running time, cost and reliability.

The attribute of the gateway node comprises name, gateway type, carrier, running time, cost and reliability. Further, the gateway types include but not limited to parallel type, inclusive type, exclusive type and complex type. The parallel type gateway is called parallel gateway node.

The attribute of the event node comprises name, event type, carrier, running time, cost and reliability; further, the event types include but not limited to start event, intermediate event, and end event.

The attribute of the logical relationship comprises source node, target node and transfer time to express the execution sequence of the activity node, gateway node and event node and the time consumed by task transfer.

The attribute of the data flow comprises name, data entity name, data type, data size, source node, target node and transfer time to express the generation of a set of data in the source node and the transfer of the same into the target node for use; further, the data types include but not limited to number, string, dictionary, and list, both the source node and the target node shall be from the set consisting of the workflow nodes participated by all participants.

The attribute of the resource flow comprises name, resource entity name, resource type, resource weight, source node, target node and transfer time to express the generation of a set of resources in the source node and the transfer of the same into the target node for use; further, the resource types include but not limited to food, daily necessities, cloths, electronics, and hybrid, both the source node and the target node shall be from the set consisting of the workflow nodes participated by all participants.

The attribute of the cash flow comprises name, cash entity name, cash type, cash volume, source node, target node and transfer time to express the generation of a certain amount of cash in the source node and the transfer of the same into the target node for use; further, the cash types include but not limited to all currency types that can circulate in the scope of the whole or part of the world such as Ren Min Bi, US Dollar, Japanese Yen and Bitcoin; both the source node and the target node shall be from the set consisting of the workflow nodes participated by all participants.

The running time comprises node time and transfer time, wherein the node time comes from the running time of the activity node, the gateway node and the event node, the transfer time comes from the transfer time of the logical relationship in the workflow. The method for calculating the running time in a service pattern is as follows:

$$𝒯 = \{ \begin{matrix}{{\sum }^{N}}_{i = 1} {𝒯}_{i}^{n} / {R}_{i}^{n} + {{\sum }^{F}}_{j = 1} {𝒯}_{j}^{f} , sequence part \\ {max}_{1 \leq k \leq K} \{ {𝒯}_{k} \} , parallel gateway part \\ {{\sum }^{K}}_{k = 1} {α}_{k} ( {𝒯}_{k} ) , other gateway part\end{matrix}$$

Where, [symbol] represents the running time of the pattern, [symbol] ⁿ and Rᵢⁿ respectively represent the running time and reliability of node i in the pattern, [symbol] ⁿ/Rᵢⁿ represents the node time of node i in the pattern, [symbol] ^{f} represents the transfer time of logical relationship j, [symbol] represents the running time of branch k after the gateway, aₖ represents the probability of running branch k after the gateway, N, F and K respectively represent the number of nodes, the number of logical relationships and the number of branches after the gateway nodes of the sequence part. The process of calculating the running time is as follows:

Step 1: taking the first executed node in the service pattern as the current node n, taking the running time of the current node as running time t, if n is an event, assuming the running time of the event node as 0;

Step 2: finding set sl of all logical relationships that take the current node n as source node;

Step 3: finding set sn of the target nodes of all logical relationships in sl;

Step 4: if the current node n is an end event, returning running time t, ending the process; if the current node n is other event node or activity node except for the end event, executing step 5; if the current node is parallel gateway, executing step 7; if the current node is other type of gateway except for parallel gateway, executing step 8;

Step 5: taking the sum of the value of itself plus the sum of the transfer time of all logical relationships in sl and the running time of all nodes in sn as running time t, if there is event node in sn, assuming the running time of the event node as 0;

Step 6: taking each node in sn as the current node n, execute step 2;

Step 7: taking the sum of the value of itself plus the max value of the sum of the running time of all logical relationships in sl and the rest part service pattern after that as running time t, the running time of the rest part service pattern is respectively recalculated starting from step 1, returning the finally obtained running time t, ending the process;

Step 8: taking the sum of the value of itself plus the sum of the running time of all logical relationships in sl and the rest part service pattern after that multiplied by the probabilities of entering corresponding branch as running time t, the running time of the rest part service pattern is respectively recalculated starting from step 1, returning the finally obtained running time t, ending the process.

The cost comprises running cost and waiting cost; the method for calculating the cost in a service pattern is as follows:

$$𝒞 = \{ \begin{matrix}{{\sum }^{N}}_{i = 1} ( {𝒞}_{i}^{b} + {𝒞}_{i}^{w} {ℒ}_{i}^{w} ) , sequence part and parallel gateway part \\ {{\sum }^{K}}_{k = 1} {α}_{k} ( {𝒞}_{k} ) , other gateway part\end{matrix}$$

Wherein, [symbol] represents the cost of the pattern, [symbol] ᵢ^{b} represents the running cost of node i, [symbol] ^{w} represents the cost increased for every unit of time that node i waits, [symbol] ᵢ ^{w} represents the time that node i needs to wait in the pattern, [symbol] ₖ represents the cost of branch k after the gateway, αₖ represents of the probability of running branch k after the gateway, N represents the number of nodes of the sequence part and the parallel gateway part, K represents the number of nodes after other types of gateway nodes except for parallel gateway.

The process of calculating the cost is as follows:

Step 1: taking the first executed node in the service pattern as the current node n, taking the cost of the current node as cost c, if n is event node, assume the cost of the event node as 0;

Step 2: finding set sl of all logical relationships that take the current node n as source node;

Step 3: finding set sn of the target nodes of all logical relationships in sl;

Step 4: if the current node n is an end event, returning cost c, ending the process; if the current node n is other event node or activity node except for the end event, executing step 5; if the current node is parallel gateway, executing step 7; if the current node is other type of gateway except for parallel gateway, executing step 8;

Step 5: taking the sum of the value of itself plus the sum of the running cost and waiting cost of all nodes in sn as running cost c, if there is event node in sn, assume both the running cost and waiting cost of the event node as 0;

Step 6: taking each node in sn as the current node n, executing step 2;

Step 7: taking the sum of the value of itself plus the sum of the costs of the rest part service pattern after all logical relationships in sl as cost c, the cost of the rest part service pattern is respectively recalculated starting from step 1, returning the finally obtained cost c, ending the process;

Step 8: taking the sum of the value of itself plus the sum of the cost of the rest part service pattern after all logical relationships in sl multiplied by the probabilities of entering corresponding branch as cost c, the cost of the rest part service is respectively recalculated starting from step 1, returning the finally obtained cost c, ending the process.

The transfer efficiency comprises data transfer efficiency, resource transfer efficiency and cash transfer efficiency; the method for calculating the transfer efficiency is as follows:

$$ε = {\sum }_{o = d , ρ , q} {η}_{o} {f}_{o} ( 𝔼 ( \frac{{ϵ}_{o}}{\vert {𝒯}^{s , t} \vert} ) )$$

Where, [symbol] represents pattern efficiency; [symbol] represents E-step; d, p and q respectively represent subscripts of data, resource and cash; ϵ₀ represents data size or resource weight or cash volume; | [symbol] ^{s,t}| represents the intermediate time from the generation or release of data/resource/cash by node s to the consumption of the same by node t; η₀ and ƒ₀ represent the coefficient and primary function that normalize different types of efficiencies to the same cash norm.

The process of calculating the transfer efficiency is as follows:

Step 1: finding set sd of all data flows in the service pattern, set sr of all resource flows, and set sq of all cash flows;

Step 2: for each data flow d in sd, calculating the efficiency of each data flow based on the data volume, data unit of the data entity in d and the transfer time of the logical relationships in d to constitute set sde of the data flow transfer efficiencies;

Step 3: unifying the data units of the data entities in each data flow d in sd as ud, calculating the average data transfer efficiency esde in the service pattern;

Step 4: for each resource flow r in sr, calculating the efficiency of each resource flow based on the resource volume, resource unit of the resource entity in r and the transfer time of the logical relationships in r to constitute set sre of the resource flow transfer efficiencies;

Step 5: unifying the resource units of the resource entities in each resource flow r in sr as ur, calculating the average resource transfer efficiency esre in the service pattern;

Step 6: for each cash flow q in sq, calculating the efficiency of each cash flow based on the cash volume, cash unit of the cash entity in q and the transfer time of the logical relationships in q to constitute set sqe of the cash flow transfer efficiencies;

Step 7: unifying the cash units of the cash entities in each cash flow q in sq as uq, calculating the average cash transfer efficiency esqe in the pattern;

Step 8: based on the different ratios of ud, ur and uq under actual conditions, determining data normalization coefficient η_{d} and primary function ƒ_{d}; determining resource normalization coefficient ηᵣ and primary function ƒᵣ; determining data normalization coefficient η_{q} and primary function ƒ_{q};

Step 9: the transfer efficiency of the pattern is the sum of the results of esde, esre and esqe respectively converted through corresponding primary functions and multiplied by corresponding coefficients, ending the process.

The value refers to the additional cash generated from the exchange between cash and resource in the service pattern. To a certain participant, his/her value is the difference between the sum of the cash and resource expected to be spent by him/her in the pattern and the sum of the cash and resource obtained by him/her. The sum of the values of all participants is the sum of the values of the pattern. For example, a seller sells a computer to a consumer at a price of RMB 10,000. In fact, the purchase price of the computer is RMB 5,000. However, the consumer can create RMB 20,000 cash using the computer. Therefore, in this process, the seller and the consumer respectively create RMB 5,000 cash and RMB 10,000 cash. The value of the pattern is 5000+10000=RMB 15,000. The method for calculating the value in a pattern is as follows:

$$= {\sum }_{p ∈ ℙ} {p}_{} \\ {p}_{} = S U M V ( p , {𝕍}^{t} , {ℝ}^{t} ) - S U M V ( p , {𝕍}^{s} , {ℝ}^{s} ) \\ SUMV ( p , 𝕍 , ℝ ) = + {\sum }_{r ∈ ℝ} {α}_{r , p} {Ψ}_{r , p} r$$

[symbol] ₚ is the value of participant p, [symbol] and [symbol] respectively represent set of spent cash, set of spent resource, set of obtained cash, and set of obtained resource. α_{v,p} and α_{r,p} respectively represent the rates of successful transfer of cash and resource in respective of participant p, Ψ_{r,p} is the cash conversion rate of resource r of participant p.

The process of calculating the value is as follows:

Step 1: finding set sp of all participants in the service pattern;

Step 2: for each participant p in sp, executing steps 4-9 to obtain corresponding set spy of values of each participant p in sp;

Step 3: calculating value v of the service pattern as the sum of all values in spy, ending the process;

Step 4: finding set spqt of all cash flows of which the target nodes are the nodes participated by p; finding set spqs of all cash flows of which the source nodes are the nodes participated by p; finding set sprt of all resource flows of which the target nodes are the nodes participated by p; finding set sprs of all cash flows of which the source nodes are the nodes participated by p;

Step 5: calculating sum spqts of the products of all cash flows in spqt multiplied by their probabilities of occurrence;

Step 6: calculating sum spqss of the products of all cash flows in spqs multiplied by their probabilities of occurrence;

Step 7: calculating sum sprts of the products of all resource flows in sprt multiplied by their probabilities of occurrence and multiplied by their cash conversion rates relative to participant p;

Step 8: calculating sum sprss of the products of all resource flows in sprs multiplied by their probabilities of occurrence and multiplied by their cash conversion rates relative to participant p;

Step 9: calculating value pv of participant p in the pattern, being the difference between the sum of spqts and sprts and the sum of spqss and sprss.

The reliability is the rate of successful running of the service, which is used to measure the probability of running as required of the activities in the service process; the method for calculating the reliability is as follows:

$$ℛ = \{ \begin{matrix}{{\prod }^{N}}_{i = 1} {ℛ}_{i} , sequence part \\ {min}_{1 \leq k \leq K} {ℛ}_{k} , parallel gateway part \\ {{\sum }^{K}}_{k = 1} {α}_{k} {ℛ}_{k} , other gateway part\end{matrix}$$

Wherein, [symbol] represents the reliability of the service pattern, [symbol] ᵢ represents the reliability of node i, [symbol] ₖ represents the reliability of branch k after the gateway, αₖ represents the probability of running branch k after the gateway, N represents the number of nodes of the sequence part and the parallel gateway part, K represents the number of branches after the gateway nodes.

The process of calculating the reliability is as follows:

Step 1: taking the first executed node in the service pattern as the current node n, taking the reliability of the current node as reliability r, if n is event node, assuming the reliability of the event node as 1;

Step 2: finding set sl of all logical relationships that take the current node n as source node;

Step 3: finding set sn of the target nodes of all logical relationships in sl;

Step 4: if the current node n is an end event, returning reliability r, ending the process; if the current node n is other event node or activity node except for the end event, executing step 5; if the current node is parallel gateway, executing step 7; if the current node is other type of gateway except for parallel gateway, executing step 8;

Step 5: taking the product of the value of itself multiplied by the product of the reliabilities of all nodes in sn as reliability r, if there is event node in sn, assuming both the running reliability and waiting reliability of the event node as 1;

Step 6: taking each node in sn as the current node n, executing step 2;

Step 7: taking the product of the value of itself multiplied by the min value of the reliabilities of the rest part service pattern after all logical relationships in sl as reliability r, the reliability of the rest part service pattern is respectively recalculated starting from step 1, returning the finally obtained reliability r, ending the process;

Step 8: taking the sum of the value of itself plus the sum of the reliability of the rest part service pattern after all logical relationships in sl multiplied by the probabilities of entering corresponding branch as reliability r, the reliability of the rest part service pattern is respectively recalculated starting from step 1, returning the finally obtained reliability r, ending the process.

The calculation of the value of the pattern entropy is dependent on five quantitative indicators: running time, consumption cost, transfer efficiency, value and reliability, which is in positive correlation with running time and consumption cost, and is in negative correlation with transfer efficiency and reliability, which is used for overall evaluation of the pattern; further, the lower the value of the pattern entropy is, the better the service pattern is. The method for calculating the pattern entropy is as follows:

$$= \frac{{θ}_{1} {f}_{1} ( 𝒯 ) + {θ}_{2} {f}_{2} ( 𝒞 )}{N * {θ}_{3} {f}_{3} ( ℛ ) * {θ}_{4} {f}_{4} ( ) * {θ}_{5} {f}_{5} ( ε )}$$

Where, ƒ₁, ƒ₂, ƒ₃, ƒ₄ and ƒ₅ represent same or different direct ratio primary functions, including but not limited to linear function and exponential function. θ₁, θ₂, θ₃, θ₄ and θ₅ represent same or different coefficients, N represents the number of nodes in the pattern.

The process of calculating the pattern entropy is as follows:

Step 1: calculating the running time [symbol] , cost [symbol] , reliability [symbol] , value [symbol] , transfer efficiency £ and number of nodes N of the service pattern;

Step 2: determining [symbol] and corresponding normalization functions ƒ₁, ƒ₂, ƒ₃, ƒ₄, ƒ₅;

Step 3: determining [symbol] and corresponding normalization functions θ₁, θ₂, θ₃, θ₄, θ₅;

Step 4: calculating pattern entropy per formula

$$\frac{{θ}_{1} {f}_{1} ( 𝒯 ) + {θ}_{2} {f}_{2} ( 𝒞 )}{N * {θ}_{3} {f}_{3} ( ℛ ) * {θ}_{4} {f}_{4} ( ) * {θ}_{5} {f}_{5} ( ε )} ,$$

ending the process.

Compared with the prior art, the evaluation method provided in the present invention builds model of process, data, resource and cash at the same time, which is able to conduct quantitative evaluation of the service pattern for crossover service, helping product manager, entrepreneur, business consultant and business designer analyze and optimize the methods for participants synergy, service selection, activity orchestration and resource distribution etc. in the service pattern.

### BRIEF DESCRIPTION OF THE DRAWINGS

FIG. 1 is schematic of the structure of the sequence part of the pattern of the service pattern quantitative evaluation method for crossover services of the present invention;

FIG. 2 is schematic of the structure of the parallel gateway part of the pattern of the service pattern quantitative evaluation method for crossover services of the present invention;

FIG. 3 is the schematic of the structure of other gateway parts of the service pattern quantitative evaluation method for crossover services of the present invention;

FIG. 4 is schematic flow chart of the service pattern quantitative evaluation method for crossover services of the present invention;

FIG. 5 is the UML schematic of the pattern model of the service pattern quantitative evaluation method for crossover services of the present invention.

### DETAILED DESCRIPTION OF THE EMBODIMENTS

Below is further description of the present invention in conjunction with figures and examples. It shall be noted that these examples are for the explanation of the present invention rather than limiting the scope of the present invention. For the operating methods without noting specific conditions in the examples below, generally, normal conditions or conditions recommended by manufacturers are to be followed.

Below is specific explanation of the technical solution of the present invention taking E-commerce third party pattern as an example.

Here is general description of E-commerce third party pattern. In E-commerce third party pattern, there are four participants. Consumers and sellers are different individuals. The activities used by them are provided by E-commerce company. Financial institutes and logistics companies provide their services to help consumers and sellers complete transactions together. At the beginning of E-commerce industry development, most enterprises adopted this pattern. In E-commerce third party pattern E-commerce companies are only responsible for establishing online shopping platform that matches consumers and sellers. The completion of the exchange of cash and resource requires support of third parties logistics company and financial institute. Therefore, user's data, resource and cash need to exchange among different platforms or applications.

It can be seen that conventional model description tends to be qualitative description of a certain major aspect of the service pattern. It is lack of comprehensiveness, quantifiableness and calculablenes s.

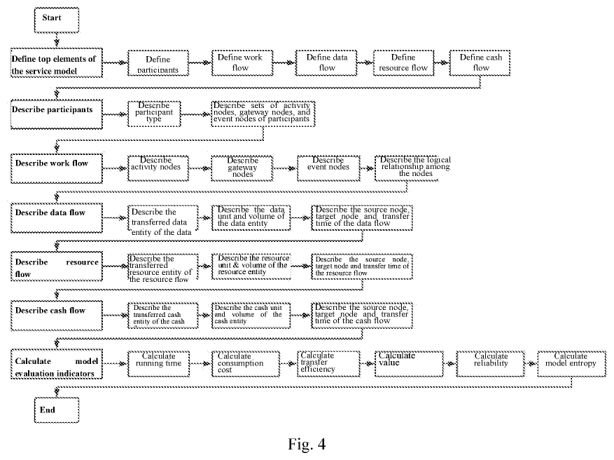

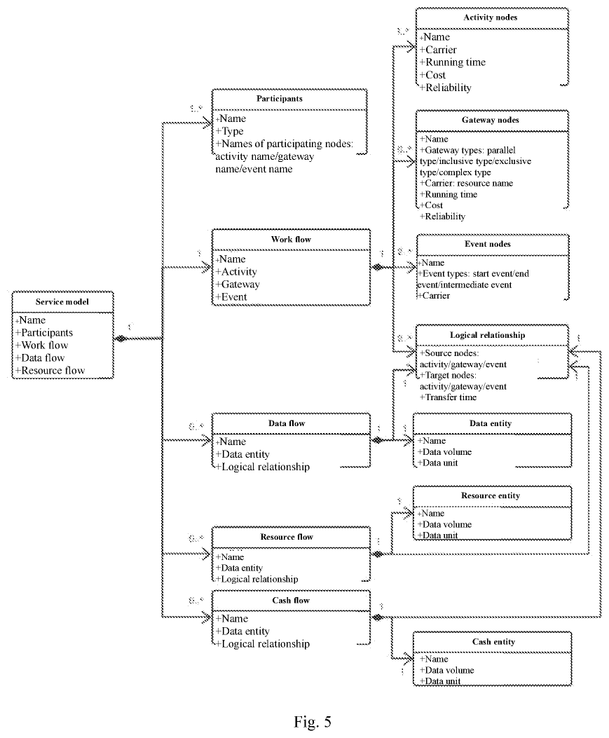

FIG. 5 shows the UML schematic of the E-commerce third party pattern provided in this example, while FIG. 4 shows the schematic flow chart of its quantitative evaluation method.

Below is the description of E-commerce platform pattern in the technical solution of the present invention.

1. Model E-commerce platform

1.1 Defining participants

{Seller, consumer, logistics company, financial institute}

1.2 Defining workflow

{ Online transaction workflow}

1.3 Defining data flow

{Seller transaction logistics data flow, consumer transaction logistics data flow, goods return logistics data flow}

1.4 Defining resource flow

{Transaction resource flow, goods return resource flow}

1.5 Defining cash flow

{Prepayment cash flow, seller settlement cash flow, logistics settlement cash flow, goods return logistics cash flow, goods return refund cash flow}

2. Describe participants in the E-commerce platform pattern

{Seller, self-employed merchant type, { deliver goods, agree to return goods, confirm receiving returned goods, gateway 2}}

{Consumer, individual consumer type, {place order, pay for the order, confirm receiving goods, apply for goods return, deliver goods to be returned, gateway 1, event 1}}

{Logistics company, third party logistics company type, {transport goods, transport goods to be returned}}

{Financial institute, third party financial institute type, {confirm payment, settle, refund, event 2, event 3}}

3. Describe workflow. “Online transaction workflow” is the set of description of the following activity nodes, gateway nodes, event nodes and logical relationships.

3.1 Describe activity nodes in the workflow

{Deliver goods, E-commerce platform carrier, 60 seconds, 1RMB, 99.5%}

{Agree to return goods, E-commerce platform carrier, 60 seconds, 1RMB, 99.5%}

{Confirm receiving returned goods, E-commerce platform carrier, 60 seconds, 1 RMB, 99.5%}

{Place order, E-commerce platform carrier, 120 seconds, 1RMB, 99.5%}

{Pay for the order, E-commerce platform carrier, 120 seconds, 1RMB, 99.5%}

{Confirm receiving goods, E-commerce platform carrier, 120 seconds, 1RMB, 99.5%}

{Apply for goods return, E-commerce platform carrier, 120 seconds, 1RMB, 99.5%}

{Deliver goods to be returned, E-commerce platform carrier, 1RMB, 99.5%}

{Transport goods, logistics platform carrier, 3 days, 6RMB, 99.5%}

{Transport goods to be returned, logistics platform carrier, 3 days, 6 RMB, 99.5%}

{Confirm payment, financial platform carrier, 1 second, 1RMB, 99.5%}

{Settle, financial platform carrier, 1 second, 1RMB, 99.5% }

{Refund, financial platform carrier, 1 second, 1RMB, 99.5%}

3.2 Describe gateway nodes in the workflow

{Gateway 1, exclusive type, E-commerce platform carrier, 1 second, 1RMB, 99.5%}

{Gateway 2, exclusive type, E-commerce platform carrier, 1 second, 1RMB, 99.5%}

3.3 Describe event nodes in the workflow

{Event 1, start event, E-commerce platform carrier}

{Event 2, end event, financial platform carrier}

{Event 3, end event, financial platform carrier}

3.4 Describe the logical relationship among the three types of nodes in the workflow

{Event 1, place order, 0.05 seconds}

{Place order, pay for the order, 0.05 seconds}

{Pay for the order, confirm payment, 2 seconds}

{Confirm payment, deliver goods, 100 seconds}

{Deliver goods, transport goods, 100 seconds}

{Transport goods, gateway 1, 100 seconds}

{Gateway 1, confirm receiving goods, 0.05 seconds}

{Gateway 2, apply for returning goods, 0.05 seconds}

{Confirm receiving goods, settlement, 2 seconds}

{Settlement, event 2, 0.05 seconds}

{Apply for returning goods, agree to return goods, 100 seconds}

{Agree to return goods, gateway 2, 0.05 seconds}

{Gateway 2, refund, 2 seconds}

{Gateway 2, deliver goods to be returned, 100 seconds }

{Deliver goods to be returned, transport goods to be returned, 100 seconds}

{Transport goods to be returned, confirm receiving returned goods, 100 seconds}

{Confirm receiving returned goods, refund, 2 seconds}

{Refund, event 3, 0.05 seconds}

4. On the basis of the workflow among the participants, describe the data flow among the participants

{Seller transaction logistics data flow,{seller transaction logistics data entity, 2000, Byte}, {transport goods, settle, 259301.05 seconds}}

{Consumer transaction logistics data flow, {consumer transaction logistics data entity, 2000, Byte}, {transport goods, confirm receiving goods, 259521.05 seconds }}

{Goods return logistics data flow, {goods return logistics data entity, 2000, Byte}, {transport goods to be returned, confirm receiving returned goods, 259300 seconds}}

5. On the basis of the workflow among the participants, describe the resource flow among the participants

{Transaction resource flow, {transaction resource entity, 1000, gram}, {deliver goods, confirm receiving goods, 259461.05 seconds}}

{Goods return resource flow, {Goods return resource entity, 1000, gram}, {Deliver goods to be returned, confirm receiving returned goods, 259520 seconds}}

6. On the basis of the workflow among the participants, describe the cash flow among the participants

{Prepayment cash flow, {prepayment cash entity, 200, RMB }, {pay for the order, confirm payment, 122 seconds}}

{Seller settlement cash flow, {seller settlement cash entity, 180, RMB }, { settle, deliver goods, 259583.05 seconds}}

{Logistics settlement cash flow, {logistics settlement cash entity, 20, RMB }, {settle, transport goods, 259423.05 seconds}}

{Goods return logistics cash flow, {goods return logistics cash entity, 20, RMB }, {deliver goods to be returned, transport goods to be returned, 220 seconds}}

Goods return refund cash flow, { goods return refund cash entity, 200, RMB }, {Refund, deliver goods to be returned, 259582 seconds}}

7. Based on the service pattern described, calculating the running time, consumption cost, transfer efficiency, value, reliability and pattern entropy; for easy understanding, we make this convention: a) each gateway node has the equal probability of entering each branch path; b) every 1000 g goods are relative to RMB 100 cash of seller, and are relative to RMB 400 cash of consumer; c) when calculating the transfer efficiency of the service pattern, the conversion rate of data relative to cash is 1 RMB/2000Byte, the conversion rate of resource relative to cash is 1RMB/5g; d) when calculating pattern entropy, all primary functions ƒ₁, ƒ₂, ƒ₃, ƒ₄ and ƒ₅ adopt identity function ƒ(x)=x, θ₁=1/86400, θ₂=θ₃=θ₄=θ₅=1.

### 7.1 Calculating Running Time

The method for calculating running time is as follows:

$$𝒯 = \{ \begin{matrix}{{\sum }^{N}}_{i = 1} {𝒯}_{i}^{n} / {R}_{i}^{n} + {{\sum }^{F}}_{j = 1} {𝒯}_{j}^{f} , sequence part \\ {max}_{1 \leq k \leq K} \{ {𝒯}_{k} \} , parallel gateway part \\ {{\sum }^{K}}_{k = 1} {α}_{k} ( {𝒯}_{k} ) , other gateway part\end{matrix}$$

Wherein, T represents the running time of the pattern, [symbol] ᵢⁿ respectively represent the running time and reliability of node i in the pattern, [symbol] ᵢⁿ/Rᵢⁿ represents the node time of node i in the pattern, [symbol] ᵢ^{ƒ} represents the transfer time of logical relationship j, [symbol] ₖ represents the running time of branch k after the gateway, αₖ represents the probability of running branch k after the gateway, N, F and K respectively represent the number of nodes, the number of logical relationships and the number of branches after the gateway nodes of the sequence part.

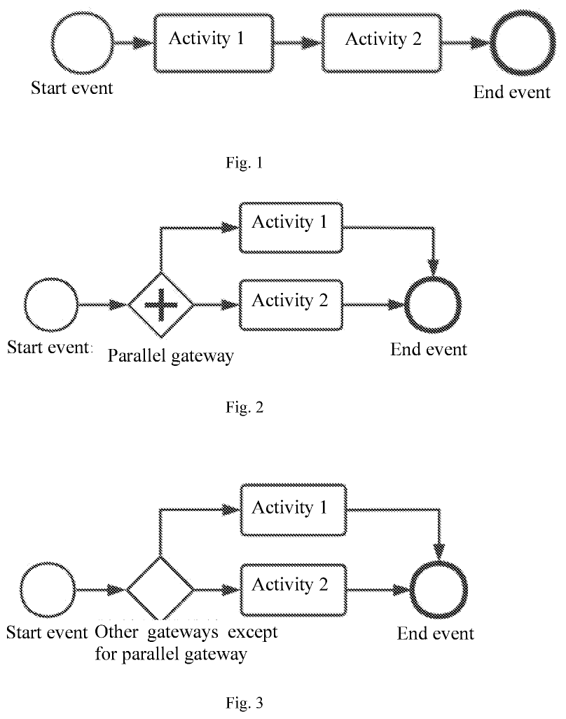

FIG. 1-3 respectively show the schematic structures of the sequence part, the parallel gateway part and other gateway part.

The calculation process is as follows:

Step 1: n=event 1, t=0

Step 2: sl={{event 1, place order, 0.05 seconds}}

Step 3: sn={{place order, E-commerce platform carrier, 120 seconds, 1RMB, 99.5%}}

Step 4: executing step 5

Step 5: t=t+0.05+120=120.05

Step 6: taking “place order” as the current node, executing step 2

Step 2: sl={{place order, pay for the order, 0.05 seconds}}

Step 3: sn={{pay for the order, E-commerce platform carrier, 120 seconds, 1RMB, 99.5%}}

Step 4: executing step 5

Step 5: t=t+0.05+120=240.1

Step 6: taking “pay for the order” as the current node, executing step 2

Step 2: sl={{Pay for the order, confirm payment, 2 seconds}}

Step 3: sn={{Confirm payment, financial platform carrier, 1 second, 1 RMB, 99.5%}}

Step 4: executing step 5

Step 5: t=t+2+1=243.1

Step 6: taking “confirm payment” as the current node, executing step 2

Step 2: s1={{Confirm payment, deliver goods, 100 seconds}}

Step 3: sn={{deliver goods, E-commerce platform carrier, 60 seconds, 1 RMB, 99.5%}}

Step 4: executing step 5

Step 5: t=t+100+60=403.1

Step 6: taking “deliver goods” as the current node, executing step 2

Step 2: s1={{Deliver goods, transport goods, 100 seconds}}

Step 3: sn={{Transport goods, logistics platform carrier, 3 days, 6 RMB, 99.5%}}

Step 4: executing step 5

Step 5: t=t+100+3*24*60*60=259 703.1

Step 6: taking “transport goods” as the current node, executing step 2

Step 2: sl={{transport goods, gateway 1, 100 seconds}}

Step 3: sn={{gateway 1, exclusive type, E-commerce platform carrier, 1 second, 1 RMB, 99.5%}}

Step 4: executing step 5

Step 5: t=t+100+1=259804.1

Step 6: taking “gateway 1” as the current node, executing step 2

Step 2: sl={{gateway 1, confirm receiving goods, 0.05 seconds}, {gateway 1, apply for returning goods, 0.05 seconds}}

Step 3: sn={{confirm receiving goods, E-commerce platform carrier, 120 seconds, 1 RMB, 99.5%}, {apply for goods return, E-commerce platform carrier, 120 seconds, 1RMB, 99.5%}}

Step 4: executing step 8

Step 8: t=t*(0.5*the running time of the rest part service pattern with “confirm receiving goods” as the first execution node+0.5*the running time of the rest part service pattern with “apply for returning goods” as the first execution node), returning t, ending the process. In the above process, the process of repeated iterative operation of the rest part service pattern is omitted, detailed numerical calculation is as in the formula below

Running time =0.05+120+0.05+120+2+1+100+60+100+259200+100+1+0.5*(0.05+120+2+1+0.05)+0.5 *(0.05+120+100+60+0.05+1+0.5*(2+1+0.05)+0.5*(100+120+100+259200+100+60+2+1+0.05)) =324927.725(seconds)

### 7.2 Calculating Consumption Cost

The method for calculating cost is as follows:

$$𝒞 = \{ \begin{matrix}{{\sum }^{N}}_{i = 1} ( {𝒞}_{i}^{b} + {𝒞}_{i}^{w} {ℒ}_{i}^{w} ) , sequence part and parallel gateway part \\ {{\sum }^{K}}_{k = 1} {α}_{k} ( {𝒞}_{k} ) , other gateway part\end{matrix}$$

Wherein, C [symbol] represents the cost of the pattern, [symbol] ᵢ^{b} represents the running cost of node i, [symbol] ᵢ^{w} represents the cost increased for every unit of time that node i waits, [symbol] ^{w} represents the time that node i needs to wait in the pattern, [symbol] ₖ represents the cost of branch k after the gateway, αₖ represents of the probability of running branch k after the gateway, N represents the number of nodes of the sequence part and the parallel gateway part, K represents the number of nodes after other types of gateway nodes except for parallel gateway.

The calculation process is as follows:

Step 1: n=event 1, c=0

Step 2: sl={{event 1, place order, 0.05 seconds}}

Step 3: sn={{place order, E-commerce platform carrier, 120 seconds, 1 RMB, 99.5%}}

Step 4: executing step 5

Step 5:c=c+1=1

Step 6: taking “place order” as the current node, executing step 2

Step 2: sl={{place order, pay for the order, 0.05 seconds}}

Step 3: sn={{pay for the order, E-commerce platform carrier, 120 seconds, 1 RMB, 99.5%}}

Step 4: executing step 5

Step 5: c=c+1=2

Step 6: taking “pay for the order” as the current node, executing step 2

Step 2: sl={{Pay for the order, confirm payment, 2 seconds}}

Step 3: sn={{Confirm payment, financial platform carrier, 1 second, 1 RMB, 99.5%}}

Step 4: executing step 5

Step 5: c=c+1=3

Step 6: taking “confirm payment” as the current node, executing step 2

Step 2: sl={{Confirm payment, deliver goods, 100 seconds}}

Step 3: sn={{deliver goods, E-commerce platform carrier, 60 seconds, 1RMB, 99.5%}}

Step 4: executing step 5

Step 5: c=c+1=4

Step 6: taking “deliver goods” as the current node, executing step 2

Step 2: s1={{Deliver goods, transport goods, 100 seconds}}

Step 3: sn={{Transport goods, logistics platform carrier, 3 days, 6 RMB, 99.5%}}

Step 4: executing step 5

Step 5: c=c+6=10

Step 6: taking “transport goods” as the current node, executing step 2

Step 2: s1={{transport goods, gateway 1, 100 seconds}}

Step 3: sn={{gateway 1, exclusive type, E-commerce platform carrier, 1 second, 1 RMB, 99.5%}}

Step 4: executing step 5

Step 5: c=c+1=11

Step 6: taking “gateway 1” as the current node, executing step 2

Step 2: s1={ {gateway 1, confirm receiving goods, 0.05 seconds}, {gateway 1, apply for returning goods, 0.05 seconds}}

Step 3: sn={ {confirm receiving goods, E-commerce platform carrier, 120 seconds, 1RMB, 99.5%}, {apply for goods return, E-commerce platform carrier, 120 seconds, 1RMB, 99.5%}}

Step 4: executing step 8

Step 8: c=c+(0.5*the consumption cost of the rest part service pattern with “confirm receiving goods” as the first execution node+0.5*the consumption cost of the rest part service pattern with “apply for returning goods” as the first execution node), returning c, ending the process.

In the above process, the process of repeated iterative operation of the rest part service pattern is omitted, detailed numerical calculation is as in the formula below:

Consumption cost =1+1+1+1+6+1+0.5*(1+1)+0.5*(1+1+0.5*1+0.5*(1+6+1+1)) =15.5(RMB)

### 7.3 Calculating Transfer Efficiency

The method for calculating transfer efficiency is as follows:

$$ε = {\sum }_{o = d , ρ , q} {η}_{o} {f}_{o} ( 𝔼 ( \frac{{ϵ}_{o}}{\vert {𝒯}^{s , t} \vert} ) )$$

Wherein, represents pattern efficiency; [symbol] represents E-step; d, p and q respectively represent subscripts of data, resource and cash; ϵₒ represents data size or resource weight or cash volume; | [symbol] ^{st}| represents the intermediate time from the generation or release of data/resource/cash by node s to the consumption of the same by node t; ηₒ ƒₒ represent the coefficient and primary function that normalize different types of efficiencies to the same cash norm.

The calculation process is as follows:

Step 1:

sd={{seller transaction logistics data flow, {seller transaction logistics data entity, 2000, Byte}, {transport goods, settle, 259301.05 seconds}}, {consumer transaction logistics data flow, {consumer transaction logistics data entity, 2000, Byte}, {transport goods, confirm receiving goods, 259521.05 seconds}}, {goods return logistics data flow, {goods return logistics data entity, 2000, Byte}, {transport goods to be returned, confirm receiving returned goods, 259300 seconds}}}

sr={{transaction resource flow, {transaction resource entity, 1000, gram}, {deliver goods, confirm receiving goods, 259461.05 seconds }}, {goods return resource flow, {goods return resource entity, 1000, gram}, {deliver goods to be returned, confirm receiving returned goods, 259520 seconds}}}

sq={{prepayment cash flow, {prepayment cash entity, 200, RMB }, {pay for the order, confirm payment, 122 seconds}}, {seller settlement cash flow, {seller settlement cash entity, 180, RMB}, {settle, deliver goods, 259583.05 seconds}}, {logistics settlement cash flow, {logistics settlement cash entity, 20, RMB }, {settle, transport goods, 259423.05 seconds }}, {goods return logistics cash flow, {goods return logistics cash entity, 20, RMB }, {deliver goods to be returned, transport goods to be returned, 220 seconds }}, {goods return refund cash flow, {goods return refund cash entity, 200, RMB }, {refund, deliver goods to be returned, 259582 seconds}}}

Step 2: sde={2000/259301.05, 2000/259521.05, 2000/259300}

Step 3: esde=(2000/259301.05+2000/259521.05+2000/259300)/3

Step 4: sre={1000/259461.05, 1000/259520}

Step 5: esre=(1000/259461.05+1000/259520)/2

Step 6:

sqe={200/122, 180/259583.05, 20/259423.05, 20/220, 200/259582}

Step 7: esqe=(200/122+180/259583.05+20/259423 .05+20/220+200/259582)/5

Step 8: determining data normalization coefficient η_{d}=1/2000 and primary function ƒ_{d}(x)=x ; determining resource normalization coefficient ηᵣ=1/5 and primary function ƒᵣ(x)=x; determining data normalization coefficient η_{q}=1 and primary function ƒ_{q}(x)=x;

Step 9:

Transfer efficiency =1/2000*(2000/259301.05+2000/259521.05+2000/259300)/3+1/5*(1000/259461.05+1000 /259520)/2+1*(200/122+180/259583.05+20/259423.05+20/220+200/259582)/5 =0.34713346379786 (RMB/second)

### 7.4 Calculating value

The method for calculating value is as follows:

$$= {\sum }_{p ∈ ℙ} {p}_{} \\ {p}_{} = S U M V ( p , {𝕍}^{t} , {ℝ}^{t} ) - S U M V ( p , {𝕍}^{s} , {ℝ}^{s} ) \\ SUMV ( p , 𝕍 , ℝ ) = + {\sum }_{r ∈ ℝ} {α}_{r , p} {Ψ}_{r , p} r$$

is the value of participant p, [symbol] and [symbol] respectively represent set of spent cash, set of spent resource, set of obtained cash, and set of obtained resource. α_{v,p} and α_{r,p} respectively represent the rates of successful transfer of cash and resource in respective of participant p, Ψ_{r,p} is the cash conversion rate of resource r of participant p.

The calculation process is as follows:

Step 1: sp={seller, consumer, logistics company, financial institute};

Step 2: for each participant p in sp, executing steps 4-9 to obtain corresponding value of each participant p in sp; the calculation process of steps 4-9 has been reflected in the formula below, no further description;

Seller: 0.5*180+0.25*0.1*1000-0.5*0.1*1000=65

Consumer: 0.5*0.4*1000+0.25*200-1*200-0.25*0.4*1000=-50

Logistics company: 0.5*20+0.25*20=15

Financial institute: 1*200-0.25*200-0.5*180-0.5*20=50

spv={65, −50, 15, 50};

Step 3: calculating value v of the pattern as the sum of all values in spv, equal to RMB80, ending the process;

7.5 Calculating Reliability

The method for calculating reliability is as follows:

$$ℛ = \{ \begin{matrix}{{\prod }^{N}}_{i = 1} {ℛ}_{i} , sequence part \\ {min}_{1 \leq k \leq K} {ℛ}_{k} , parallel gateway part \\ {{\sum }^{K}}_{k = 1} {α}_{k} {ℛ}_{k} , other gateway part\end{matrix}$$

Wherein, [symbol] represents the reliability of the service pattern, [symbol] represents the reliability of node i, [symbol] ₖ represents the reliability of branch k after the gateway, αₖ represents the probability of running branch k after the gateway, N represents the number of nodes of the sequence part and the parallel gateway part, K represents the number of branches after the gateway nodes.

The process of calculating the reliability is as follows:

The calculation process is as follows:

Step 1: n=event 1, r=1

Step 2: s1={{event 1, place order, 0.05 seconds}}

Step 3: sn={ {place order, E-commerce platform carrier, 120 seconds, 1RMB, 99.5%}}

Step 4: executing step 5

Step 5: r=r * 0.995 =0.995

Step 6: taking “place order” as the current node, executing step 2

Step 2: s1={{place order, pay for the order, 0.05 seconds}}

Step 3: sn={{pay for the order, E-commerce platform carrier, 120 seconds, 1RMB, 99.5%}}

Step 4: executing step 5

Step 5: r=r * 0.995 =0.990025

Step 6: taking “pay for the order” as the current node, executing step 2

Step 2: s1={{Pay for the order, confirm payment, 2 seconds}}

Step 3: sn={{Confirm payment, financial platform carrier, 1 second, 1RMB, 99.5%}}

Step 4: executing step 5

Step 5: r=r *0.995 =0.985074875

Step 6: taking “confirm payment” as the current node, executing step 2

Step 2: s1={ {Confirm payment, deliver goods, 100 seconds}}

Step 3: sn={{deliver goods, E-commerce platform carrier, 60 seconds, 1RMB, 99.5%}}

Step 4: executing step 5

Step 5: r=r * 0.995=0.980149500625

Step 6: taking “deliver goods” as the current node, executing step 2

Step 2: s1={ {Deliver goods, transport goods, 100 seconds}}

Step 3: sn={ {Transport goods, logistics platform carrier, 3 days, 6 RMB, 99.5%}}

Step 4: executing step 5

Step 5: r =r *0.995 =0.97524875312187

Step 6: taking “transport goods” as the current node, executing step 2

Step 2: s1={ {transport goods, gateway 1, 100 seconds }}

Step 3: sn={ {gateway 1, exclusive type, E-commerce platform carrier, 1 second, 1RMB, 99.5%}}

Step 4: executing step 5

Step 5: r=r * 0.995 =0.97037250935627

Step 6: taking “gateway 1” as the current node, executing step 2

Step 2: s1={{gateway 1, confirm receiving goods, 0.05 seconds}, {gateway 1, apply for returning goods, 0.05 seconds} }

Step 3: sn={{confirm receiving goods, E-commerce platform carrier, 120 seconds, 1RMB, 99.5%}, {apply for goods return, E-commerce platform carrier, 120 seconds, 1 RMB, 99.5%}}

Step 4: executing step 8

Step 8: r=r*(0.5*the reliability of the rest part service pattern with “confirm receiving goods” as the first execution node+0.5*the reliability of the rest part service pattern with “apply for returning goods” as the first execution node), returning r, ending the process.

In the above process, the process of repeated iterative operation of the rest part service pattern is omitted, detailed numerical calculation is as in the formula below:

Reliability =0.995*0.995*0.995*0.995*0.995*0.995*(0.5*0.995*0.995+0.5*0.995*0.995*(0.5*0.995 +0.5*0.995*0.995*0.995)) =0.955907561

### 7.6 Calculating Pattern Entropy

In accordance with the method for calculating pattern entropy in claim 14, the calculation process is as follows:

Step 1: calculating the pattern's running time [symbol] as 324927.725(seconds), cost [symbol] as 15.5 (RMB), reliability [symbol] as 0.955907561, value [symbol] as 80 (RMB), transfer efficiency [symbol] as 1.732568933(RMB/second), and number of nodes N as 15;

Step 2: determining that all of the corresponding normalization functions ƒ₁, ƒ₂, ƒ₃, ƒ₄ and ƒ₅ of [symbol] and [symbol] are the identity function ƒ(x)=x;

Step 3: determining that the corresponding normalization coefficient of [symbol] and [symbol] is θ₁=1/86400, θ₂=θ₃=θ₄=θ₅=1;

Step 4: calculating pattern entropy per formula

$$\frac{{θ}_{1} {f}_{1} ( 𝒯 ) + {θ}_{2} {f}_{2} ( 𝒞 )}{N * {θ}_{3} {f}_{3} ( ℛ ) * {θ}_{4} {f}_{4} ( ) * {θ}_{5} {f}_{5} ( ε )} ,$$

as follows:

Model entropy =(1/86400*324927.725+15.5)/(15*1.732568933*80*0.955907561) =0.009691372

Ending the process.

1. A service pattern quantitative evaluation method for crossover services, comprising:
(1) defining top elements of the service pattern, including defining participants, workflow, data flow, resource flow and cash flow;
(2) describing participants in the service pattern;
(3) describing the workflow among the participants based on existing participants;
(4) on the basis of the workflow among the participants, describing the data flow among the participants;
(5) on the basis of the workflow among the participants, describing the resource flow among the participants;
(6) on the basis of the workflow among the participants, describing the cash flow among the participants;
(7) based on the described workflow, data flow, resource flow and cash flow, calculating the evaluation indicators of the service pattern, including running time, consumption cost, transfer efficiency, value, and reliability; and calculating pattern entropy based on the evaluation indicators to conduct overall evaluation of the service pattern, wherein the lower the value of the pattern entropy is, the better the service pattern is.

2. A service pattern quantitative evaluation method for crossover services according to claim 1, characterized in that, in step (2), the attribute of the participant comprises role name, role type, and nodes of role participation, the nodes of role participation comprise activity node, gateway node and event node;
in step (3), the workflow comprises activity node, gateway node, event node and logical relationship;
in step (4), the attribute of the data flow comprises name, data entity and logical relationship to express the generation of a set of data in the source node and the transfer of the same into the target node for use; the attribute of the data entity comprises name, data volume and data unit;
in step (5), the attribute of the resource flow comprises name, resource entity and logical relationship to express the generation of a set of resources in the source node and the transfer of the same into the target node for use; the attribute of the resource entity comprises name, resource volume and resource unit;
in step (6), the attribute of the cash flow comprises name, cash entity, logical relationship to express the generation of a set of cashes in the source node and the transfer of the same into the target node for use; the attribute of the cash entity comprises name, cash volume and cash unit;
in step (7), the running time comprises node time and transfer time; the cost comprises running cost and waiting cost; the transfer efficiency comprises data transfer efficiency, resource transfer efficiency and cash transfer efficiency; the value is the difference between the total cash volume created by the service pattern and the total cash volume consumed; the reliability is the ratio of successful service running, which is used to measure the probability that the activity node in the service flow runs as required.

3. A service pattern quantitative evaluation method for crossover service according to claim 2, characterized in that, the attribute of the activity node comprises name, carrier, running time, cost and reliability; the attribute of the gateway node comprises name, gateway type, carrier, running time, cost and reliability; the gateway types include parallel type, inclusive type, exclusive type and complex type; the parallel type gateway is called parallel gateway; the attribute of the event node comprises name, event type, carrier; the event types include start event, intermediate event and end event; the attribute of the logical relationship comprises source node, target node, transfer time to express the execution sequence among the activity node, gateway node and event node and the time consumed for task transfer.

4. A service pattern quantitative evaluation method according to claim 3, characterized in that, the method for calculating the running time is as follows:
Step 1: taking the first executed node in the service pattern as the current node n, taking the running time of the current node as running time t, if n is event node, assuming the running time of the event node as 0;
Step 2: finding set sl of all logical relationships that take the current node n as source node;
Step 3: finding set sn of the target nodes of all logical relationships in sl;
Step 4: if the current node n is an end event, returning running time t, ending the process; if the current node n is other event node or activity node except for the end event, executing step 5;
if the current node is parallel gateway, executing step 7; if the current node is other type of gateway node except for parallel gateway, executing step 8;
Step 5: taking the sum of the value of itself plus the sum of the transfer time of all logical relationships in sl and the running time of all nodes in sn as running time t, if there is event node in sn, assuming the running time of the event node as 0;
Step 6: taking each node in sn as the current node n, executing step 2;
Step 7: taking the sum of the value of itself plus the max value of the sum of the running time of all logical relationships in sl and the rest part service pattern after that as running time t, the running time of the rest part service pattern is respectively recalculated starting from step 1, returning the finally obtained running time t, ending the process;
Step 8: taking the sum of the value of itself plus the sum of the running time of all logical relationships in sl and the rest part service pattern after that multiplied by the probabilities of entering corresponding branch as running time t, the running time of the rest part service pattern is respectively recalculated starting from step 1, returning the finally obtained running time t, ending the process.

5. A service pattern quantitative evaluation method according to claim 3, characterized in that, the method for calculating the cost is as follows:
Step 1: taking the first executed node in the service pattern as the current node n; taking the cost of the current node as cost c; if n is event node, assuming the cost of the event node as 0;
Step 2: finding set sl of all logical relationships that taking the current node n as source node;
Step 3: finding set sn of the target nodes of all logical relationships in sl;
Step 4: if the current node n is an end event, returning cost c, ending the process; if the current node n is other event node or activity node except for the end event, executing step 5; if the current node is parallel gateway, executing step 7; if the current node is other type of gateway except for parallel gateway, executing step 8;
Step 5: taking the sum of the value of itself plus the sum of the running cost and waiting cost of all nodes in sn as running cost c; if there is an event node in sn, assuming both the running cost and waiting cost of the event node as 0;
Step 6: taking each node in sn as the current node n, executing step 2;
Step 7: taking the sum of the value of itself plus the sum of the costs of the rest part service pattern after all logical relationships in sl as cost c, the cost of the rest part service pattern is respectively recalculated starting from step 1, returning the finally obtained cost c, ending the process;
Step 8: taking the sum of the value of itself plus the sum of the cost of the rest part service pattern after all logical relationships in sl multiplied by the probabilities of entering corresponding branch as cost c, the cost of the rest part service is respectively recalculated starting from step 1, returning the finally obtained cost c, ending the process.

6. A service pattern quantitative evaluation method according to claim 3, characterized in that, the method for calculating the transfer efficiency is as follows:
Step 1: finding set sd of all data flows in the service pattern, set sr of all resource flows, and set sq of all cash flows;
Step 2: for each data flow d in sd, calculating the efficiency of each data flow based on the data volume, data unit of the data entity in d and the transfer time of the logical relationships in d to constitute set sde of the data flow transfer efficiencies;
Step 3: unifying the data units of the data entities in each data flow d in sd as ud, calculating the average data transfer efficiency esde in the service pattern;
Step 4: for each data flow r in sr, calculating the efficiency of each resource flow based on the resource volume, resource unit of the resource entity in r and the transfer time of the logical relationships in r to constitute set sre of the resource flow transfer efficiencies;
Step 5: unifying the resource units of the resource entities in each resource flow r in sr as ur, calculating the average resource transfer efficiency esre in the service pattern;
Step 6: for each cash flow q in sq, calculating the efficiency of each cash flow based on the cash volume, cash unit of the cash entity in q and the transfer time of the logical relationships in q to constitute set sqe of the cash flow transfer efficiencies;
Step 7: unifying the cash units of the cash entities in each cash flow q in sq as uq, calculating the average cash transfer efficiency esqe in the service pattern;
Step 8: based on the different ratios of ud, ur and uq under actual conditions, determining data normalization coefficient η_{d} and primary function ƒ_{d}; determining resource normalization coefficient ηᵣ and primary function ƒᵣ; determining data normalization coefficient η_{q} and primary function ƒ_{q};
Step 9: the transfer efficiency of the service pattern being the sum of the results of esde, esre and esqe respectively converted through corresponding primary functions and multiplied by corresponding coefficients, ending the process.

7. A service pattern quantitative evaluation method according to claim 3, characterized in that, the method for calculating the value is as follows:
Step 1: finding set sp of all participants in the service pattern;
Step 2: for each participant p in sp, executing steps 4-9 to obtain corresponding set spy of values of each participant p in sp;
Step 3: calculating value v of the service pattern as the sum of all values in spy, ending the process;
Step 4: finding set spqt of all cash flows of which the target nodes are the nodes participated by p; finding set spqs of all cash flows of which the source nodes are the nodes participated by p;
finding set sprt of all resource flows of which the target nodes are the nodes participated by p;
finding set sprs of all resource flows of which the source nodes are the nodes participated by p;
Step 5: calculating sum spqts of the products of all cash flows in spqt multiplied by their probabilities of occurrence;
Step 6: calculating sum spqss of the products of all cash flows in spqs multiplied by their probabilities of occurrence;
Step 7: calculating sum sprts of the products of all resource flows in sprt multiplied by their probabilities of occurrence and multiplied by their cash conversion rates relative to participant p;
Step 8: calculating sum sprss of the products of all resource flows in sprs multiplied by their probabilities of occurrence and multiplied by their cash conversion rates relative to participant p;
Step 9: calculating value pv of participant p in the service pattern, being the difference between the sum of spqts and sprts and the sum of spqss and sprss.

8. A service pattern quantitative evaluation method according to claim 3, characterized in that, the method for calculating the reliability is as follows:
Step 1: taking the first executed node in the service pattern as the current node n, taking the reliability of the current node as reliability r, if n is event node, assuming the reliability of the event node as 1;
Step 2: finding set sl of all logical relationships that take the current node n as source node;
Step 3: finding set sn of the target nodes of all logical relationships in sl;
Step 4: if the current node n is an end event, returning reliability r, ending the step; if the current node n is other event node or activity node except for the end event, executing step 5; if the current node is parallel gateway, executing step 7; if the current node is other type of gateway except for parallel gateway, executing step 8;
Step 5: taking the product of the value of itself multiplied by the product of the reliabilities of all nodes in sn as reliability r, if there is an event node in sn, assuming both the running reliability and waiting reliability of the event node as 1;
Step 6: taking each node in sn as the current node n, executing step 2;
Step 7: taking the product of the value of itself multiplied by the min value of the reliabilities of the rest part service pattern after all logical relationships in sl as reliability r, the reliability of the rest part service pattern is respectively recalculated starting from step 1, returning the finally obtained reliability r, ending the process;
Step 8: taking the sum of the value of itself plus the sum of the reliability of the rest part service pattern after all logical relationships in sl multiplied by the probabilities of entering corresponding branch as reliability r, the reliability of the rest part service pattern is respectively recalculated starting from step 1, returning the finally obtained reliability r, ending the process.

9. A service pattern quantitative evaluation method according to claim 3, characterized in that, the method for calculating the pattern entropy is as follows:
Step 1: calculating the running time [symbol] cost [symbol] , reliability [symbol] , value V, transfer efficiency and number of nodes N of the service pattern;
Step 2: determining [symbol] and corresponding normalization functions ƒ₁, ƒ₂, ƒ3, ƒ4, ƒ5;
Step 3: determining [symbol] and corresponding normalization functions θ₁, θ₂, θ₃, θ₄, θ₅;
Step 4: calculating pattern entropy per formula
$$\frac{{θ}_{1} {f}_{1} ( 𝒯 ) + {θ}_{2} {f}_{2} ( 𝒞 )}{N * {θ}_{3} {f}_{3} ( ℛ ) * {θ}_{4} {f}_{4} ( ) * {θ}_{5} {f}_{5} ( ε )} ,$$
ending the process.

10. A service pattern quantitative evaluation method according to claim 1, the service pattern of the crossover service is e-commerce third party pattern.
